(19) United States
(12) Patent Application Publication
(10) Pub. No.: US 2012/0207308 A1
(43) Pub. Date: Aug. 16, 2012

(54) INTERACTIVE SOUND PLAYBACK DEVICE

(76) Inventor: Po-Hsun SUNG, Taichung (TW)

(21) Appl. No.: 13/027,886

(22) Filed: Feb. 15, 2011

(51) Int. Cl. H04R 5/00

(52) U.S. Cl. 381/17

(57) ABSTRACT

An interactive sound playback device includes two speakers, two microphones, a motion sensor, and an audio processing unit. The speakers and the microphones are disposed at two sides of the interactive sound playback device respectively. The audio processing unit is electrically connected to the speakers, the microphones, and the motion sensor, and has a recording mode and a playing mode. In the recording mode, the audio processing unit receives a motion sensing signal from the motion sensor and a first audio signal from the microphones, stores the first audio signal, and stores the motion sensing signal as position information. In the playing mode, the audio processing unit outputs the first audio signal to the speakers through a first path, or adjusts a second audio signal by referring to the motion sensing signal and the position information, and outputs the adjusted second audio signal to the two speakers through a second path.

### BACKGROUND OF THE INVENTION

1. Field of Invention

The present invention relates to an interactive sound playback device, and more particularly to an interactive sound playback device constructed by motion sensing, which is capable of synchronously adjusting the sensed stereo sound with rotation of the head of a wearer.

2. Related Art

The technologies for implementing virtual reality that are widely used at present include the so-called augmented reality (AR) and immersion virtual reality. The so-called AR refers to a technology in which a user wears a transparent display apparatus on the head, such that scenes in the real world are directly compounded with computer-generated images, which is essentially a specific type of virtual reality. The immersion of the real scene mainly aims to improve the sensing effect. In an AR system, it has two elements, which is quite different from virtual reality. One element is objects in the real scene that cannot be fully constructed or simulated by the computer due to the complexity, which mainly aims to improve the execution effect of relevant tasks in the real world. The other element is the compounding and interaction of the real and the virtual. In conclusion, the AR has three characteristics: 1. combining the virtual world and the real world; 2. capable of achieving real-time interaction; and 3. being operated in a three-dimensional (3D) environment.

The difference between the immersion virtual reality and the AR lies in the degree of immersion. The so-called immersion virtual environment is required to provide an environment that a user can be completely immersed in to sense the environment like the real one in the virtual space. Therefore, in order to achieve the immersion virtual reality, in addition to the creation of sense signals received by the user such as sight, hearing, and touch, psychology must be taken into consideration at the same time, such that the user has hallucination and cannot distinguish the virtual environment and the real environment. The system needs to cover such input to create a realistic artificial world, which is a complicated issue in technology.

In the 1980s, the NASA of USA implemented a plan of Virtual Interactive Environment Workstation, and began the research on virtual interaction related technologies. The conventional virtual interaction technologies are mainly to sense the motion of human body and the 3D vision and to output sound in combination, which mainly relies on technologies of positioning and directionality of sound, and binaural stereo effect. In the 1980s-1990s, relevant 3D sound effect technologies such as Dolby Laboratory, DTS, and SRS were developed, and the conventional research of spatial acoustics and auditory sense was applied to actual products with the application of the movie entertainment, audio technology, and 3C consumer products. These technologies may also be applied in multimedia playing of virtual reality, in combination with the 3D display technology and 5.1 channel, 7.1 channel, and even the latest 11.1 channel, the user may experience the 3D sound field feeling of the virtual reality in a playing environment with the apparatuses. However, the virtual environment implemented by such technologies still belongs to passive feeling. Although the user has an immersed sensory feeling, he or she still cannot interact with the virtual environment.

In the interaction technology, several major gaming machine manufacturers have produced interactive gaming machines, which can achieve the feeling of interacting with games through the motion of the human body by sensing the motion of the user. However, in the construction of the sound field environment applied, even if multiple channels can be connected for output, the sound output is still the actual environmental stereo sound, and the imaging of the 3D sound field cannot be adjusted with the rotation of the head of the user, such that the user still can distinguish the real environment and the sound field environment of interactive games, and cannot be immersed in the games realistically.

### SUMMARY OF THE INVENTION

Accordingly, the present invention is directed to an interactive sound playback device, which is capable of synchronously adjusting the stereo sound sensed by a wearer with rotation of the head of the wearer.

In order to achieve the above objectives, the interactive sound playback device of the present invention comprises two speakers, two microphones, a motion sensor, and an audio processing unit. The two speakers and the two microphones are disposed at two sides of the interactive sound playback device. The audio processing unit is electrically connected to the two speakers, the two microphones, and the motion sensor, and has a recording mode and a playing mode. In the recording mode, the audio processing unit receives a motion sensing signal from the motion sensor and a first audio signal from the two microphones, stores the first audio signal, and stores the motion sensing signal as position information. In the playing mode, the audio processing unit directly outputs the first audio signal to the two speakers for playing through a first path, or adjusts a second audio signal by referring to the motion sensing signal and the position information, and outputs the adjusted second audio signal to the two speakers for playing through a second path.

In order to achieve the above objectives, the interactive sound playback device of the present invention further comprises a camera electrically connected to the audio processing unit, thus being applicable to an immersion virtual reality system.

Based on the above, compared with the prior art, in the present invention, microphones are disposed at two ears of the user to directly store the sound, so an environmental sound is recorded in a first mode, and the sound is reproduced to the speakers at the two ears in a second mode, and the reproduced sound can even be adjusted according to different positions of the head of the user in the two modes. Further, if the interactive sound playback device is integrated in a device in combination with an AR system including a camera, the processing technology for the AR may be improved to the immersion virtual reality, and at the same time, a 3D image is displayed, and the binaural sound effect is felt, thereby providing an optimal virtual reality for the user.

### BRIEF DESCRIPTION OF THE DRAWINGS

The present invention will become more fully understood from the detailed description given herein below for illustration only, and thus are not limitative of the present invention, and wherein:

FIG. 1 is a schematic view illustrating an application of an interactive sound playback device of the present invention;

FIG. 2 is a diagram illustrating motions of the interactive sound playback device of the present invention in a recording mode;

FIG. 3 is diagram illustrating motions of the interactive sound playback device of the present invention in a playing mode; and

FIG. 4 is a schematic diagram illustrating an internal circuit of a digital signal processor in the interactive sound playback device of the present invention.

### DETAILED DESCRIPTION OF THE INVENTION

Hereinafter, embodiments of an interactive sound playback device in the present invention are described with reference to the accompanying drawings.

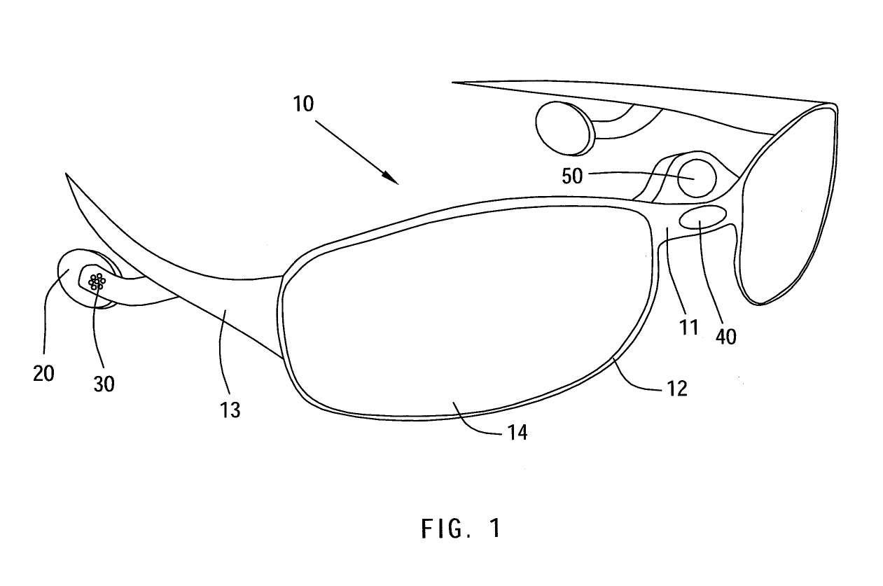

Referring to FIG. 1, a schematic view illustrating an application of an interactive sound playback device of the present invention is shown. In this application example, the interactive sound playback device is implemented as a structure with the main body being a pair of spectacles 10, but not limited thereto. The spectacles 10 include a nose rack 11, two spectacle frames 12 extending from two sides of the nose rack 11, and two spectacle temples 13 extending from the two spectacle frames 12. The two spectacle frames 12 have a lens 14 fitted therein respectively.

The interactive sound playback device further includes two speakers 20, two microphones 30, a motion sensor 40, and an audio processing unit. The two speakers 20 and the two microphones 30 are respectively disposed to extend from the middle part of the two spectacle temples 13. The motion sensor 40 is embedded in the nose rack 11. The audio processing unit may be implemented as a chip structure and assembled in the spectacle temples 13 or the nose rack 11, and is electrically connected to the two speakers 20, the two microphones 30, and the motion sensor 40 respectively. The audio processing unit is designed to have two operation modes. In a recording mode, the audio processing unit receives a motion sensing signal from the motion sensor 40 and a first audio signal from the two microphones 30, stores the first audio signal, and stores the motion sensing signal as position information. In a playing mode, the audio processing unit directly outputs the first audio signal to the two speakers 20 for playing, or adjusts a second audio signal by referring to the motion sensing signal and the position information, and outputs the adjusted second audio signal to the two speakers 20 for playing through a second path.

The motion sensor 40 may be, for example, implemented as a sensing element such as a triaxial accelerometer or a gyro.

The second audio signal may be generated by an external device and input to the audio processing unit, or may be originally built in the audio processing unit.

The position information may be, for example, azimuth and elevation angles.

In addition to the implementation of being built in the spectacles 10, the audio processing unit may also be disposed in a control box alone, and signals generated by the components on the spectacles 10 such as the speakers 20, the microphones 30, and the motion sensor 40 may be transmitted between the components and the control box by wireless technology.

The interactive sound playback device of the present invention further includes a camera 50 disposed on the nose rack 11. A file of an image recorded by the camera 50 is transferred to a computer or digital processor with the AR processing function through wired transmission or wireless transmission, and then a 3D picture is generated after processing and is presented on a surface of the lenses 14 facing the eyes; moreover, the lenses 14 are not transparent herein. Furthermore, through the AR processing technology, information related to the viewed target may also be displayed on the semi-transparent lenses 14. Thus, the information may be superposed on the picture of the viewed target.

It should be noted that, in addition to be integrated in the spectacles 10 as shown in FIG. 1, the interactive sound playback device of the present invention may also be integrated in a portable device such as a smart phone, a personal digital assistant (PDA), or a personal camera, and the two speakers 20, the two microphones 30, and the motion sensor 40 may be integrated in an earphone to be connected to the device. When the user wears the earphone, the two speakers 20 and the two microphones 30 are located at the ears of the user, and the motion sensor 40 is designed to be at the center of the top of the head or the center of the forehead.

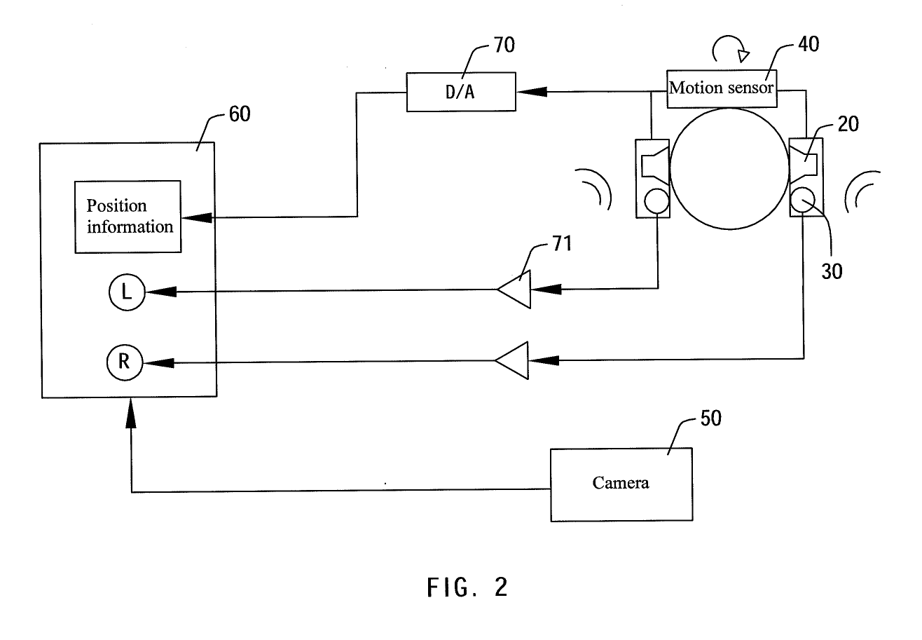

Next, referring to FIG. 2, a diagram illustrating motions of the interactive sound playback device of the present invention in the recording mode is shown. As shown in FIG. 2, when the user wears the spectacles 10 in FIG. 1, the microphones 30 on both sides of the ears receive a sound of the external environment respectively, and such sound reception mode contains a personal head-related transfer function (HRTF) effect. At this time, the audio signal received by the microphones 30 at the left and right ears is transferred to the audio processing unit 60 through an amplifier 71 respectively, and is resolved and stored as a left channel audio signal and a right channel audio signal. Meanwhile, a motion sensing signal sensed and generated by the motion sensor 40 is transferred to an analog-to-digital (A/D) converter 70, and the motion sensing signal after being converted by the A/D converter 70 is directly transferred to the audio processing unit 60, and the audio processing unit 60 resolves and stores the sensing signal as position information. It should be further noted that, the camera 50 also synchronously records an image, and directly transfers the signal to the audio processing unit 60 for resolution and storage, such that the file can be conveniently transferred to a computer or digital processor with the AR processing function through wired transmission or wireless transmission.

It should be further noted that, in the recording mode, the user may change the positions of the body and the head with the sensing of the environment, so in recording, the signals generated by the microphones 30 and the motion sensor 40 are superposed and stored in the audio processing unit 60, and at the same time, the position information when the user changes the position each time, such that the sound field feeling sensed in the environment at that time can be realistically and truly recorded.

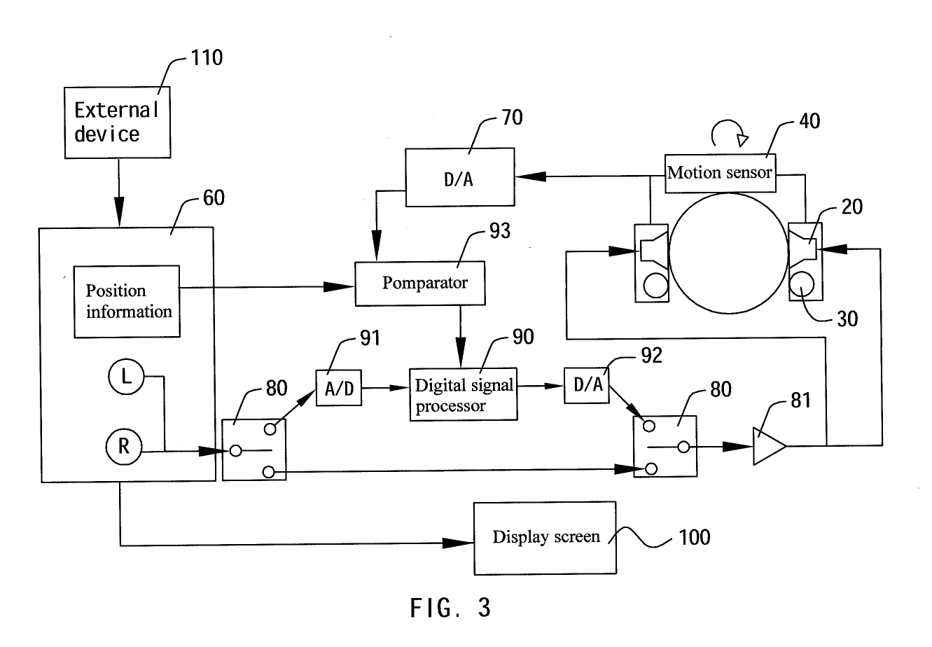

Then, referring to FIG. 3, a diagram illustrating motions of the interactive sound playback device of the present invention in the playing mode is shown. As shown in FIG. 3, in the playing mode, if the user intends to reproduce the stereo sound recorded in the recording mode, the audio processing unit 60 may select to use a switch 80 to directly transfer the left channel audio signal and the right channel audio signal to an amplifier 81 for amplification through a first path, and then transfer the amplified signals to the speakers 20 at the left and right ears. As the original left channel audio signal and right channel audio signal are audio signals containing the HRTF effect, the sound heard by the user from the speakers 20 is a binaural sound formed by stereo sound with the HRTF effect.

Furthermore, the audio processing unit 60 may also select to play a second audio signal, and herein the second audio signal may be, for example, generated by an external device 110, or built in the audio processing unit 60. Herein, the audio processing unit 60 may select to use the switch 80 to transfer the left channel audio signal and the right channel audio signal to an analog-to-digital converter (A/D) 91 through a second path and covert them into digital signals, transfer the digital signals to a digital signal processor 90 for processing, then transfer the processed signals to a digital-to-analog converter (D/A) 92 and convert them into analog audio signals, amplify the analog audio signals by the amplifier 81, and transfer the amplified signals to the speakers 20 at the left and right ears. In this mode, the digital signal processor 90 further receives a comparison signal that is sent by a comparator 93 connected between the motion sensor 40 and the audio processing unit 60, and the comparator 93 receives the motion sensing signal detected by the motion sensor 40 in the playing mode and a position information from the audio processing unit 60 that is sent by the external device 110. After receiving the comparison signal, the digital signal processor 90 adjusts the audio signal output by the audio processing unit 60 with the HRTF effect, and then transfers the audio signal to the speakers 20 at the left and the right ears.

For example, when the user is in an environment where an automobile passes in front of him or her, the sound of the automobile passing by is recorded by the two microphones 30. As the left channel audio signal and the right channel audio signal recorded in the audio processing unit 60 are audio signals containing the HRTF effect, the user may directly reproduce the binaural sound of the automobile passing by from the speakers 20 through the first path. On the other hand, the audio processing unit 60 may receive the audio signal and the position information sent by the external device such as a video game console. As the game already has audio signals corresponding to different positions, after the digital signal processor 90 receives the motion sensing signals generated when the head of the user rotates, the spatial feeling of the audio signals may be changed correspondingly, such that the user can immerse himself or herself in the spatial feeling of the game better, and thus the audio signal heard by the user through the second path feels more realistic.

Furthermore, in the playing mode, the image recorded by the camera 50 may be used by the audio processing unit 60 to generate a 3D picture, and the 3D picture is transferred to a display screen 100, or the 3D picture is transferred to a computer or digital processor with the AR processing function through the audio processing unit 60, and then is transferred to the display screen 100. Herein, the display screen 100 may be, for example, the lenses in FIG. 1 or a screen of a smart phone. If being displayed on the screen of the mobile phone, the user may directly see the 3D picture of AR from the screen, and meanwhile hear the binaural sound from the two speakers 20. However, if the display screen 100 is implemented as a screen of a notebook computer, the binaural sound may be output from a speaker built in the notebook computer, and the binaural sound effect produced is further computed by a program in the notebook computer, which will not be described herein.

It should be noted that, the interactive sound playback device of the present invention may further have a micro projector disposed thereon, for example, installed on the spectacles in FIG. 1. Thus, the 3D picture may be projected onto a wall or a screen curtain through the micro projector and be displayed as a large picture.

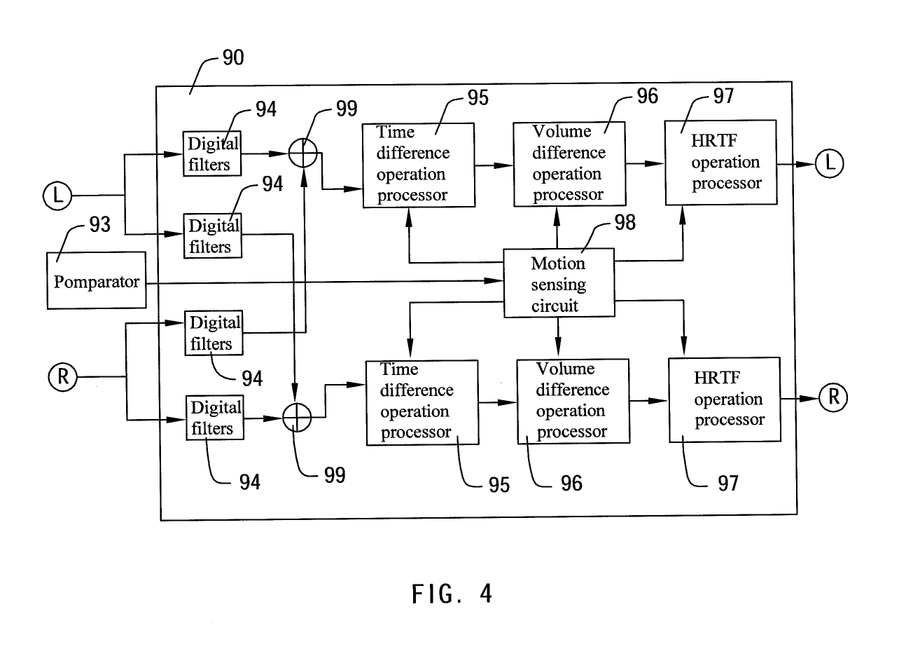

Next, referring to FIG. 4, a schematic diagram illustrating an internal circuit of the digital signal processor in the interactive sound playback device of the present invention is shown. As shown in FIG. 4, the digital signal processor 90 includes a plurality of digital filters 94, a plurality of time difference operation processors 95, a plurality of volume difference operation processors 96, a plurality of HRTF operation processors 97, a motion sensing circuit 98, and a plurality of adders 99. The left channel audio signal and the right channel audio signal are transferred to an A/D converter 91 for conversion, and then are sent to the digital filters 94 for filtering. For example, the left channel audio signal is transferred to only two corresponding digital filters 94, in which the signal processed by one digital filter 94 is transferred to an adder 99, and the signal processed by the other digital filter 94 is transferred to another adder 99. Each adder 99 for superposing the left channel audio signal and the right channel audio signal may transfer the signal to the corresponding time difference operation processor 95, volume difference operation processor 96, and HRTF operation processor 97. Furthermore, a comparison signal generated by the comparator 93 according to the motion sensing signal sent by the rotation of the head of the user and the position information output by the audio processing unit 60 is transferred to the motion sensing circuit 98, processed by the motion sensing circuit 98 to update a motion sensing reference value, and then transferred to the time difference operation processor 95, the volume difference operation processor 96, and the HRTF operation processor 97 respectively, such that the audio signal output by the audio processing unit 60 is adjusted, and thus the time phase and volume of the left channel audio signal and the right channel audio signal are adjusted. Moreover, the computational processing of an HRTF is added, such that when the finally output left channel audio signal and right channel audio signal are played by the speakers 20 at the left and right ears of the user, the effect of stereo virtual reality.

Based on the above, in the interactive sound playback device of the present invention, microphones are disposed at two ears of the user to directly store the sound, so the environmental sound at that time is recorded in a first mode, and the sound is reproduced to the speakers at the two ears in a second mode, and the reproduced sound can even be adjusted according to different positions of the head of the user in the two modes. The variation of the sound field is simulated and adjusted with the swing of the head of the user, thus having the effect of stereo virtual reality. If the interactive sound playback device is integrated in a device in combination with an AR system including a camera, the processing technology for the AR may be improved to the immersion virtual reality, so that a 3D image is displayed on the picture, and the binaural sound effect is integrated and added, thereby providing an optimal virtual reality for the user.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An interactive sound playback device, comprising:
two speakers, disposed at two sides of the interactive sound playback device;
two microphones, disposed at two sides of the interactive sound playback device, for recording a first audio signal;
a motion sensor, for detecting a body movement of a user and generating a motion sensing signal; and
an audio processing unit, electrically connected to the two speakers, the two microphones, and the motion sensor, wherein the audio processing unit has two operation modes:
a recording mode, wherein the audio processing unit receives the motion sensing signal and the first audio signal, and stores the first audio signal and stores the motion sensing signal as position information; and
a playing mode, wherein the audio processing unit directly outputs the first audio signal to the two speakers for playing through a first path, or adjusts a second audio signal by referring to the motion sensing signal and the position information, and outputs the adjusted second audio signal to the two speakers for playing through a second path.

2. The interactive sound playback device according to claim 1, wherein the second audio signal is generated by an external device and is input to the audio processing unit.

3. The interactive sound playback device according to claim 1, wherein the second audio signal is built in the audio processing unit.

4. The interactive sound playback device according to claim 2, wherein the external device further provides external position information to replace the position information generated in the recording mode.

5. The interactive sound playback device according to claim 1, wherein the motion sensor converts the motion sensing signal through an analog-to-digital converter.

6. The interactive sound playback device according to claim 1, wherein after receiving the first audio signal, the audio processing unit resolves and stores the first audio signal as a left channel audio signal and a right channel audio signal respectively.

7. The interactive sound playback device according to claim 1, further comprising a comparator electrically connected between the audio processing unit and the motion sensor, for comparing the motion sensing signal and the position information, and outputting a comparison signal to a digital signal processor, wherein the digital signal processor receives the second audio signal output by the audio processing unit at the same time, and processes the second audio signal with the comparison signal for adjustment and output.

8. The interactive sound playback device according to claim 7, wherein the digital signal processor comprises head-related transfer function (HRTF) operation processors.

9. The interactive sound playback device according to claim 7, wherein the digital signal processor comprises time difference operation processors.

10. The interactive sound playback device according to claim 7, wherein the digital signal processor comprises volume difference operation processors.

11. The interactive sound playback device according to claim 7, wherein the digital signal processor comprises a motion sensing circuit for updating a motion sensing reference value in real time.

12. The interactive sound playback device according to claim 7, wherein the digital signal processor receives a signal from an analog-to-digital converter, and outputs the signal to a digital-to-analog converter for conversion, thereby providing the audio signal.

13. The interactive sound playback device according to claim 1, wherein the audio processing unit is further electrically connected to a camera and a display screen, and with an image recorded by the camera in the recording mode, a three-dimensional (3D) picture is generated on the display screen by the audio processing unit in the playing mode.

14. The interactive sound playback device according to claim 1, wherein the audio processing unit is further electrically connected to a camera and a micro projector, and with an image recorded by the camera in the recording mode, a 3D picture is generated by the audio processing unit in the playing mode, and is projected by the micro projector.

15. The interactive sound playback device according to claim 1, wherein the motion sensor is a triaxial accelerometer or a gyro.
